(19) United States
(12) Patent Application Publication
(10) Pub. No.: US 2004/0243847 A1
(43) Pub. Date: Dec. 2, 2004

(54) Method for rejecting SPAM email and for authenticating source addresses in email servers

(76) Inventor: Gregory G. Way, Bend, OR (US)

Correspondence Address: GLENN C. BROWN, PC, 777 NW WALL STREET, SUITE 308, BEND, OR, 97701, US

(21) Appl. No.: 10/795,115

(22) Filed: Mar. 3, 2004

Related U.S. Application Data
(60) Provisional application No. 60/451,789, filed on Mar. 3, 2003.

(51) Int. Cl. H04L 9/00; G06F 15/16

(52) U.S. Cl. 713/201; 709/206

(57) ABSTRACT

This invention provides a method of blocking unwanted emails, yet provides the flexibility to permit the recipient to receive emails from new senders as desired. This invention provides a firewall with a list of approved senders as described above. In addition, however, the method of this invention permits the recipient to allow specific users to bypass the firewall.

### CROSS-REFERENCE TO RELATED APPLICATION

This application is a continuation-in-part of U.S. application serial No. 60/451,789, filed on Mar. 3, 2004. The priority of the prior application is expressly claimed and its disclosure is hereby incorporated by reference in its entirety.

### BACKGROUND OF THE INVENTION

Email has become an increasingly important and convenient method of personal and business communication. Email refers to the capability to send written communications over the internet to a specific recipient. Each email “user” is identified by a unique internet address, much like a street address. Email is implemented by any one of several specifications employed by all email providers.

The protocol for nearly all current email “systems” is defined by three Internet specifications known as “RFC” (request for comments) documents that ultimately were implemented as specifications: RFC 1939 for POP3, RFC821 for SMTP authored by Jonathan B. Postel, and the ESMTP extensions in RFC 1869. These documents are in the public domain and found primarily at www.isi.edu/in-notes, and are incorporated herein by reference in their entirety. An RDC search engine is available through www.rfc-editor.org.

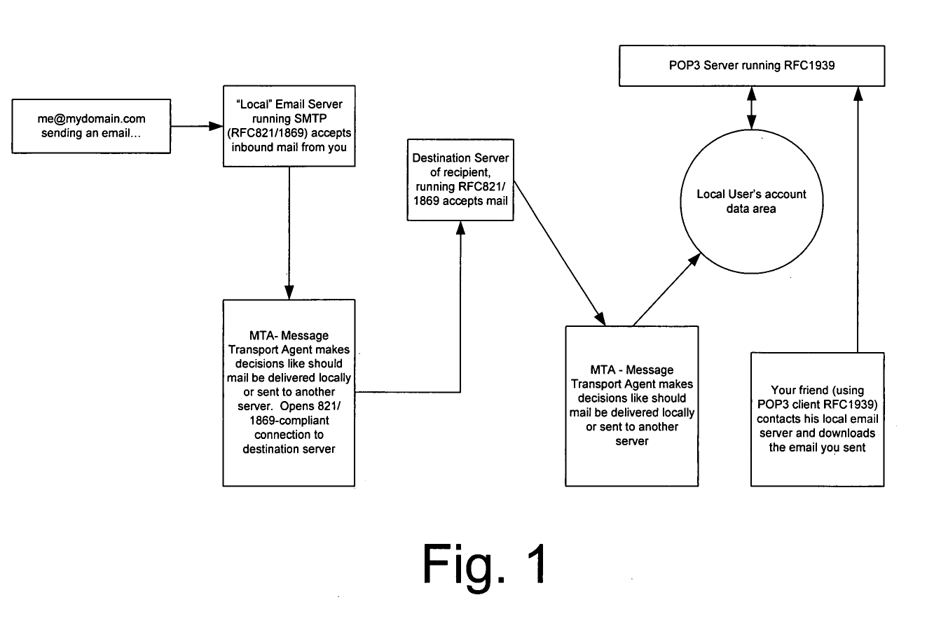

Specifications RFC821 and RFC1939 are the two primary protocols by which email servers are able to exchange mail via software running on desktop and laptop computers. RFC1939 defines the specification for our interaction with email servers in receiving email. RFC821 and 1869 define the specification for how email servers send mail to each other and get email from email users. For example, when a sender sends an email message, the email is sent first to the sender's email server, which is typically located at your email service provider's facility. RFC821/1869 defines this process. Once the sender's email server has received the message it uses software often referred to as a message transport agent (MTA) to decide how to route that email. Should it need to go to another email server, RFC821/1869 are used again to send that message to the destination email server. If you in fact had sent that message to yourself then it would be placed in a location where your software would login and receive it, using RFC1939. FIG. 1 is a simplified schematic block diagram of a typical email process as implemented today using the specifications referenced above. It should be noted that the email client or desktop software does not normally communicate with any other email servers other than the one it has been assigned. The process of moving mail around the Internet is actually left to email servers that may make many decisions based on each email they receive.

The great thing about email is that anyone can send a message to anyone, and it is typically delivered to the recipient's mail box in real-time for retrieval at the recipient's convenience. While this basic feature is in part what makes email so wonderful, it opens the door for abuse. One particularly irritating form of abuse comes in the form of the sending of unsolicited commercial email (“UCE”), also known as “SPAM”, in the Internet community. UCE, or SPAM, is an unsolicited email from a source from whom the recipient did not ask to receive email. The word “unsolicited” is the key point; the recipient did not ask nor approve the sender to send a message.

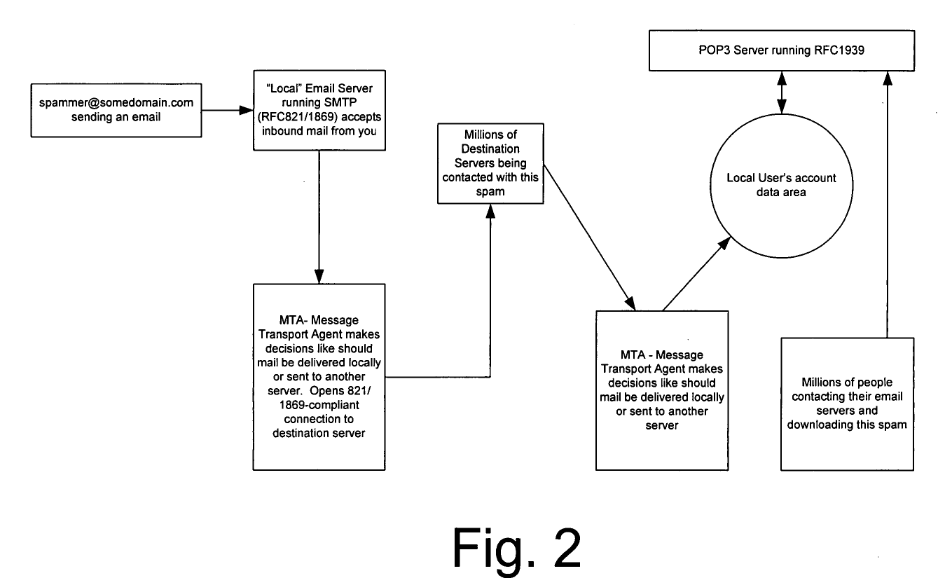

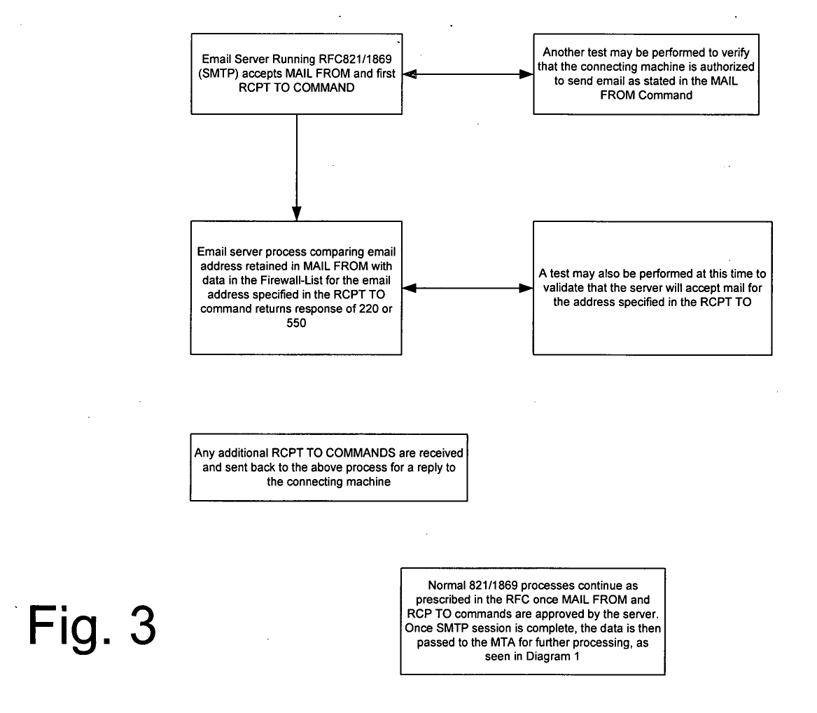

For the most part the reason we get Spam is because individuals and or companies look to profit from the seemingly low cost that email offers in reaching millions of Internet users. Spammers send email out to many people or companies to advertise the Spammer's products or services. Spammers obtain emails from vendors who buy email addresses from other merchants who have communicated with the recipient and have placed the recipient's email in a data base for their own purposes, and as a valuable piece of information that can be sold to Spammers. A typical process for sending Spam “or bulk email” to as many as a million or more recipients is shown in FIG. 2. Using the method shown in FIG. 2, the Spammer can take advantage of the ability of computers to automatically transfer a recipient's email address from a data base of email addresses to an email message (solicitation), and to then automatically send each of those emails to those many recipients, all very quickly and with very little operator intervention required.

In the early days of the Internet Spam was not a very big problem. Since then the Internet, and email in particular, has experienced explosive growth. As the use of email has grown, so has the problem of Spamming until today the problem has reached enormous proportions, costing business millions if not billions of dollars every year. While there is no reliable estimate of the. volume of Spam flowing through the Internet today, nearly all email users receive unwanted email. Many people using Internet email spend anywhere from 5 minutes to an hour each day deleting SPAM. Also, it is not uncommon to inadvertently delete important business or personal email while in the process of manually deleting the unwanted SPAM. The following block diagram expanding on Diagram (1) shows a typical process that creates 1 Spam for millions of Internet users.

Unwanted email can also take other forms. A user can wish to receive no further emails from a sender. Young users can receive emails that are sent for the purpose of engaging the young user in an inappropriate dialogue. For all of these reasons there is a need for an effective method of screening Spam and unwanted emails.

One known method for blocking Spam is quite simple. In order to block unwanted email, the recipient's email server is instructed to accept email from an approved list of email senders, and to reject email from all other senders. Any email not on this list would be promptly rejected using the unauthorized codes provided for in RFC 821. Hence the email server would remain in compliance of Internet standards. REF: R: 550 Access Denied to You. In Internet terms this accept/reject approach is known as a “Firewall”, and is implemented by software that is widely available. The term “Firewall-List” will be used herein to refer to this list and the process. The following is a schematic block diagram showing a typical Email Firewall-List and its use in an RFC821 compliant server.

However, this simple solution creates a big problem. The problem is that in everyday life people want email from people that they may have just met, or from whom they do not have advance notice of the email. Under the blocking method above, a significant advantage and utility of email is lost. A need therefore remains for a Spam blocking method that effectively blocks unwanted email, while at the same time allows the email recipient to accept and receive emails from new senders as desired.

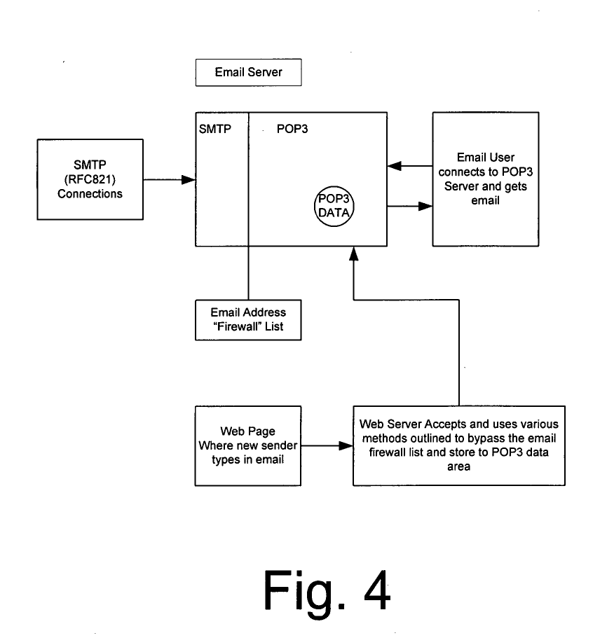

This invention provides a method of blocking unwanted emails, yet provides the flexibility to permit the recipient to receive emails from new senders as desired. This invention provides a firewall with a list of approved senders as described above. In addition, however, the method of this invention permits the recipient to allow specific users to bypass the firewall. Referring to FIG. 4, this invention achieves this solution by placing on a web server (see web server definition) a web page that is designated by the email recipient to accept an email message on behalf of a sender, and which is programmed to send it to the recipient's email server for acceptance or rejection by the recipient. In some implementations the web server may place the email message “directly” into the location of the users' account data area by completely bypassing the email server and utilizing the operating system or network capabilities to store data. Either way, the “email message” is actually created through someone entering it on a web page hosted on behalf of the recipient. The address of this web page would preferably be given out only to people from whom the recipient wanted to receive an email. For example, if one were to identify a potential business contact, that potential contact could be given the url (address) for the web page, and direct an email to the recipient through the web page. The recipient would review the email and could choose to add the sender to the approved list by merely responding to the email, at which time the recipient's email server is instructed to add the sender's name to the Firewall List if not found on the list already. If the recipient chooses to not respond, the sender would not be placed on the Firewall List, and would continue to be rejected by the firewall if the sender attempted to send an email directly to the recipient and bypass the web page.

In order for the above to act as a firewall the “source address” must be established as legitimate. The system has several processes that it goes through in order to positively identify the identity of the sender. First it will compare the domain name of the sender with the DNS reverse lookup results of the connecting machine. If a match is found then the system need only verify that that machine is not an “open relay” through commonly used open relay discovery tactics. However, if the machine name does not match the name given in the senders email address or if an open relay as described above is detected then the system must confirm that the sender has POP3 access to the email address he or she is sending from. In this scenario the system will send an email to the “sender” of the email asking for confirmation that they in fact sent the email.

```
Return-path: <gregoryway@blockallspam.com>
Received: from mx2.bendcable.com (mx2.bendable.com [192.168.17.31]) by pop-
server.bendable.com
  (Rockliffe SMTPRA 4.5.6) with ESMTP id <B0138688136@pop-server.bendcable.com>
for <glennbrown@bendcable.com>;
  Fri, 6 Feb 2004 10:52:32 −0800
Received: from [204.140.220.99] (www.blockallspam.com [204.140.220.99]) by
mx2.bendcable.com
  (Rockliffe SMTPRA 5.2.5) with ESMTP id <B000061091@mx2.bendcable.com> for
  <glennbrown@bendcable.com>;
  Fri, 6 Feb 2004 10:52:31 −0800
Message-ID: <B0000610901@mx2.bendcable.com>
Received: from blockallspam.com ([204.140.220.8]) by blockallspam.com (dedicated MTA
v6.1) with SMTP id BAS2003
From: <gregoryway@blockallspam.com>
To: glennbrown@bendcable.com
Date: Fri,06 Feb 2004 10:53:18 −0700
Subject: Source Authentication Request ID:MSG04020639198.53X
SourceAuthentication:MSG04020639198.53X.txt
Content-Type: text/html;
```

Upon receiving a reply from that email address, which includes an ID code established with the original message, the machine knows that the sender was able to check their pop3 account to get the email and reply to the message sent by our system. This POP3/IMAP4 (etc) confirmation means that the sender has access rights to send mail as the email address indicates and thus confirming they are a legitimate sender as the source address.

Additional security could be applied to the web page to protect that page from unauthorized use. In this embodiment, Spam would be stopped at the firewall since the Spam sender's source address would not be on the approved Firewall List, and since the Spammer would not have the recipient's url. Even having the url, the Spammer would be thwarted since the url address does not comply with the email specifications discussed above, which would reject the url as an invalid email address. FIG. 4 is a schematic block diagram of one embodiment of the invention showing the integration of the web page and firewall into a system that effectively thwarts Spam.

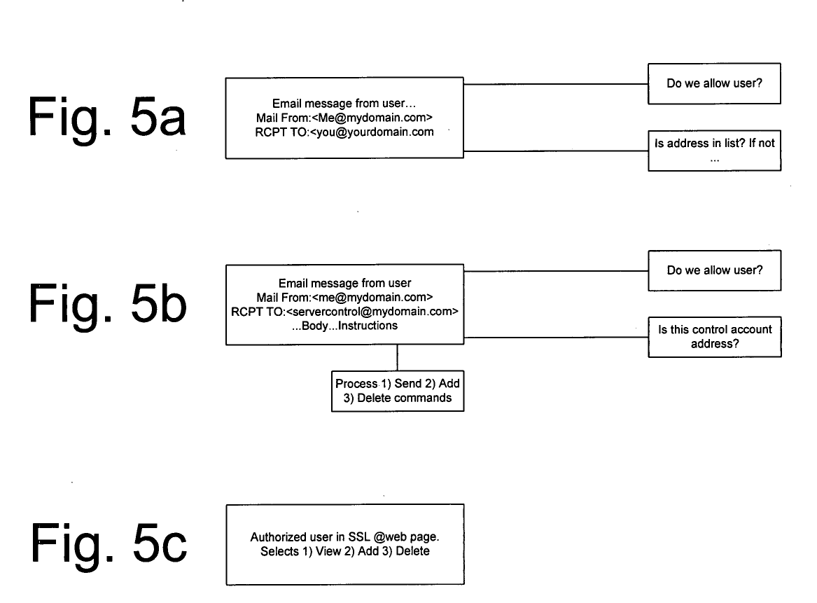

Referring now to FIG. 5a-5c, several methods by which the recipient can maintain and update the list of approved users are shown. While the processes used here are part of this patent, anyone experienced in this field may derive other means of maintaining the list of approved senders that are not defined here. This invention is not limited to any specification or firewall protocol.

In addition to amending the firewall-list as the user sends emails out, there are other means by which the list can be updated. In one embodiment the recipient's email server will permit the recipient to retrieve and view the firewall-list, and to add or remove sender email addresses from the list. The recipient's server would also permit other control related commands to be activated by the recipient. In another embodiment a web page is available to the recipient that permits the retrieval of the firewall-list and the addition or removal of senders' email addresses.

In order to protect the recipient's email account and information, authentication processes at are preferably included at each of the three points where changes to the list can be made. In the case of the recipient sending email instructions to the server, the recipient's email may be authenticated by the mere fact it comes from the same IP address that was used when “logging in” during the POP3 session to pick up email. If the recipient is accessing a “control” account, a login and password could be required or the recipient could be authenticated as in the above step. In web browser based email systems the user may be authenticated through a login/password prompt that in turn passes the information on to a system for authentication. If accepted, the user would be allowed to update the firewall-list. Below is a diagram of the three interfaces the user can go through to update the firewall-list.

### ADDITIONAL NOTES REGARDING THE INVENTION

It should be noted that while the invention has been describe by reference to the preferred embodiments described above, the invention is not limited to any particular operating system, programming language, or unmentioned underlying protocols below the TCP/IP layer.

The use of “Web Server” in this document is intended to mean any server that meets corresponding RFC and or Internet Drafts relating to this commonly known Internet technology. Our definition of “web server” is not limited to any given brand. In other words, our definition of a “Web Server” is a computer program that answers on TCP/IP internet port 80 or 443 (or other port that is in compliance) showing any resemblance of support for the specification for RFC2616(HTTP/1.1) or the RFC based standards it replaces, or RFC standards that replace RFC2616. Additional information can be found at http://www.w3.org as well as http://www.rfc-editor.org and http://www.isi.edu, and is incorporated by reference herein.

This claim states that using any “Web Server” based technology to accept an email with the intention to bypass a system that uses the described firewall-list is by definition part of this patent.

The process that occurs after the web server receives a form submission containing an email to bypass the firewall-list is defined as:

1. Connecting to the email server and sending an RFC821 compliant email with embedded commands that authenticate the email as coming from the pre-authorized web server source;

OR

2. Creating a “LAN” based connection to the location of the users' email account data area and storing the email in the format that the POP3 (RFC1939) system server would use to deliver the email to the user;

OR

3. Creating a local “file” on the hard disk through the operating system and or BIOS in the location of the users account data area.

Further definition.

The “Firewall-List” is a list of email addresses that the (each) Internet User of our systems will be provided to us through one of the described means. This list is accessed during an RFC821 session with another email server or client for the purpose of authenticating email that the connecting machine requests to be sent to the user. Any mail with a source address, known in the RFC as “MAIL FROM” that does not match this list, will be rejected using the RFC compliant code 550 Not Authorized.

POP3 Data Area- Several times in this document I refer to the location that is used by the Email client to pick up email. During a POP3 session (picking up email) as defined in RFC1939 an area of the storage media is accessed to retrieve messages that are to be sent to and downloaded by a POP3 client software program. This area is a fixed area that is predefined either by configuration data or through “hard coded” instructions in the computer source code for the server. This pre-defined area known by the developers of an email server system and potentially known by administrators or other people charged with maintenance of said system is the area referred to herein as “location of the users email account data area”.

It is feasible to identify or provide source code to every possible process that may be used to compare email addresses that are provided in the “MAIL FROM” RFC821/1869 based statement with the Firewall-List used by the email server. It is assumed that people of ordinary skill in the art of programming can create near-unlimited variations of that exact process. Rather, it is within the scope of this invention that in so implementing that process with the intention of bypassing that list with the other processes stated herein and maintaining that list with the maintenance processes stated herein together form the combination of processes that is the process that encompasses the scope of this invention.

The following is a broad summary of the elements of one embodiment of the invention:

1. A modification to any implementation RFC821/1869 in which the data provided in the MAIL FROM command is an email address, and that email address is the source address of an unknown person or machine wanting to communicate with a recipient's email address or addresses. The recipient email addresses are listed in RFC821 by the “RCPT TO” command. This command is allowed in the specification to specify one or more recipients or destination email addresses. Hence once both the source address and each destination address is known, the system will search for the source address in the firewall-files that are relevant to the destination address. Should the address exist in the firewall-list, the mail will be accepted. Should the source address not exist in the list, the email will be rejected unless a) it is otherwise determined that it is authenticated through the web server or b) the email is from a user of the email server and destined to be delivered to another email server according to the specification RFC821. If it is destined for another email server, the system does not interfere with the mail as long as the user is authenticated to send said email.

2. Related to the above step, but assuming the sender is actually the authenticated user of the system. The system will collect outbound email addresses provided in the RCPT TO processing of the RFC821 implementation and add those addresses to the firewall-list. It should be noted that this might be implemented as something the user could turn on or off.

3. A Web Server based system RFC2616 (or similar derivative) that bypasses the above firewall to deliver mail. A web server, “web pages”, and the processes to which a web server accepts form data are all in the public domain. The exact process of taking that data and creating an email message that will be stored in the users' email account data area is open to unlimited potential implementations. It is beyond the scope of this document to define each potential process to accomplish that task. The implementation of this process is part of the patent in the scope of it being used in conjunction with the other two components listed herein.

4. An RFC821/1869 or RFC2616 based means of collecting authenticated commands to the email server relating to maintaining the firewall list. As with the above two processes there are a virtually unlimited number of methods to implement this process. It is beyond the scope of this document to define each one. Instead, the claim is that using any method to implement this process with the intent of implementing the other process is part of this patent.

### METHOD FOR AUTHENTICATING SOURCE ADDRESSES IN EMAIL SERVERS

The invention described above includes a step of authenticating email source addresses in as a step in blocking spam email messages. Electronic Mail or “Email” is the most widely used communications tool for business and personal communication on the Internet. At the technical level, Email often also refers to an open set of programming guidelines known as specifications which programmers base their logic upon when creating software to process email messages. An email server is a machine running software developed based on the Email specifications. The specifications are known as Request For Comments “RFC” documents. The founder of Email, Jonathan B. Postel, authored the early versions of the RFC documents that are in use today. Specifically, RFC 821 and RFC 1869 are what provide the guidelines for sending and receiving email on the Internet. RFC 1939 provides the guidelines for authorized downloading of email from an email server and is also the most widely implemented specification. It is because the programmers use specifications for building email servers that any email server can pass messages to any email server on the Internet. The University of Southern California Information Sciences Institute played a significant role in the originating of many RFC documents and they maintain a web site where these specifications may be found at www.isi.edu/in-notes. An RFC search engine is also provided at www.rfc-editor.org.

Email technology provides the freedom for its users to send and receive written communications over the Internet in near real-time. This freedom exists in part because users pay for Internet services and service providers provide them with access to the Internet. There is almost never a fee paid for each message sent or received via Email. This makes the apparent cost of this extremely convenient technology minimal. In recent years however, individuals and companies looking to profit from the low cost of sending email to millions of users on the Internet have abused this freedom. So many of these email-abusing users are sending so many emails that they are now driving up the costs of email dramatically and frustrating millions of email users by making them download and sort through considerable volumes of messages that they did not want to receive. Today the problem is costing business dollar figures estimated in the billions not including the loss in productivity and is threatening the future viability of email as the rate of abuse continues to grow exponentially.

It is the mission of almost every Internet service provider to reduce the amount of Spam their customers receive and untold millions are currently being spent each year in research and development of new techniques. The source of this problem comes from the underlining fact that sending email messages is, for the most part, a process that does not require authentication. If Email messages were authorized as being from whom they claim to be from, a drastic reduction in Spam would occur and additional solutions could be put in place that would, in fact, eliminate Spam completely, or at the very least create such a barrier to abuse that it would no longer be profitable to engage in abuse practices and thus thwart the primary motive behind abuse.

This Invention provides a solution to authenticate Email messages as a foundation for Anti-Spam technologies. The technology, called “source-address-authentication” sets out a series of processes in which an email message is authenticated by virtue that the sender must have been authenticated by an email server to download email in order to reply to a confirmation email that they are in fact the authorized user of the email address specified in the ‘from’ address of the Email message. This Invention will work regardless of what techniques are used to authenticate the user. For instance, a “Web Mail” user may be sending and receiving messages through their web browser and authenticated via a web site while a “POP3 Mail” user may be sending and receiving messages through an Email client and authenticated through the POP3 specification. Both of these users are authenticated to access their email account and by replying to an email sent to that account, they confirm those rights to the destination email server. This allows the technology to source-authenticate a user without requiring advanced knowledge of what kind of email delivery system they are using.

The Invention works in conjunction with the SMTP specifications RFC812 and RFC1869, and through the implementation of a message transport agent or “MTA”. The MTA of an email server is the brains of the server in that it makes email routing decisions. When an email message comes to an email server, if it is successfully transmitted and stored it is then passed to MTA software for routing. The MTA decides whose email account it is for or if the email must be passed on for delivery to another email server or in some cases if both need to be done. The first part of the Invention sets up processes where the MTA software will temporarily store email messages that come from unauthorized sources. It will then build an email message directed to the sender of the email message asking that the sender of the email simply reply to the MTA originated email, on behalf of the named recipients. The email message also contains an ID code meaningful to the MTA software as to which email message this is for. It may or may not include an image of a word or a set of numbers embedded in the email message for the recipient to confirm that they can see by entering into a location specified by the reply email.

Critically important is that the MTA also include data that identifies itself to the email server that is now the recipient email server for the reply email that it is in fact authorized to send this “reply-email”. In addition, this data also notifies the recipient server that this message is a “reply-email” and must be sent to the recipient.

The Invention provides for two different means for this authentication to be passed to the email server of the alleged sender. The first method involves simply specifically formatted text and specific language in the reply email that identifies the message as being a reply and containing no other content. In this scenario the sending server is authenticated to send the email because the content itself is acceptable by virtue that it cannot be a Spam message. It may also include portions of the header of the original email it received to further authenticate the legitimacy of sending the reply email. In addition, the IP address of the machine sending the reply must be found in the reverse DNS lookup for the domain it claims to be from. The second method involves passing a phrase in the email header that is comprised of information that is known only to the destination server that is only for the sending server. For example, the sending server might pass something that would look like “S-Auth: XLDF4312DASSF” in the email header. If the recipient server verifies that the embedded code is what is allocated for that server to accept replies from the sending server, then it will allow the reply email to be delivered. The fallback mechanism, in case of any processing errors, would be as provided for in the first method.

Once the sender receives the email, should the sender reply to the email, that email is sent to the original recipient server. Should that email match the requirements of the MTA that originated the reply, the MTA will then release the original email sent by the sender for further processing in accordance with its design for delivery of an email message. Some anti-spam systems may implement additional processes before and after the processes of this invention that are beyond the scope of this document.

### Additional Notes Regarding the Invention

It should be noted that while the invention has been described by reference to the preferred embodiments described above, the invention is not limited to any particular operating system, programming language or unmentioned underlying protocols below or above the TCP/IP layer.

This invention is not limited to the current RFC documents specified herein. It should be noted that while it is based on RFC821/1869, it is assumed that continued expansions in the specifications would be expected and even that some mail systems may in the future use specifications that are not based on the specifications mentioned herein and that the processes described herein would still be applicable and thus part of this claim.

I claim:

1. A method of screening email messages sent over the internet comprising the steps of:
providing at least one email address for receiving incoming email messages;
providing a list of email sources that are authorized to send email messages to the at least one email address;
providing a location for storing authorized email messages for retrieval by the user of the at least one email address;
receiving an incoming email message addressed to the at least one email address;
identifying the sender of the incoming email message;
comparing the identity of the sender of the incoming email message to the list of approved email senders; and,
sending the incoming email message to the email storage location for retrieval by the user if the identity of the sender is found in the list of approved email senders.
